(19) United States
(12) Patent Application Publication
(10) Pub. No.: US 2026/0161330 A1
(43) Pub. Date: Jun. 11, 2026

(54) MACHINE LEARNING METHOD USING POOLING ON CHANNEL ATTENTION

(71) Applicant: NOVATEK Microelectronics Corp., Hsin-Chu (TW)

(72) Inventors: Chao-Tsung Huang, Hsinchu City (TW); Yen-Ting Chiu, Nantou County (TW); Yong-Tai Chen, Taichung City (TW)

(73) Assignee: NOVATEK Microelectronics Corp., Hsin-Chu (TW)

(21) Appl. No.: 18/974,703

(22) Filed: Dec. 9, 2024

(51) Int. Cl. G06F 3/08; G06N 3/0464

(52) U.S. Cl. CPC G06F 3/08; G06N 3/0464

(57) ABSTRACT

A machine learning method using pooling on channel attention includes inputting a first residual input to convolution layers of a first residual network to generate a first convolved output, and inputting the first convolved output to a first pooling layer to generate a first pooling vector. This results in a decrease in both computational time and memory usage, which in turn boosts the efficiency and performance of the machine learning model.

### BACKGROUND OF THE INVENTION

### 1. Field of the Invention

The present invention is related to a machine learning method, particularly related to a machine learning method using pooling on channel attention.

### 2. Description of the Prior Art

Convolutional neural network (CNN) models are often utilized on image processing. Researchers began to adopt attention mechanisms and embed the so-called attention layer into CNN models to achieve better interpretability and performance. The attention mechanisms applied in CNN models can learn the key features in input data to generate a key feature map through channel-wise scaling. The attention mechanism allows the CNN model to adjust its level of attention based on different parts of the input, which makes the model more capable of understanding and interpreting complex data.

However, the attention mechanism requires large amount of data access to a dynamic random access memory (DRAM). The processor must access the DRAM to load a whole feature map, and the process is quite time-intensive and consumes a significant amount of memory space.

### SUMMARY OF THE INVENTION

A machine learning method using pooling on channel attention includes inputting a first residual input to convolution layers of a first residual network to generate a first convolved output, and inputting the first convolved output to a first pooling layer to generate a first pooling vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a channel attention method.

FIG. 2 is a schematic diagram of a machine learning method using pooling on channel attention according to an embodiment of the present invention.

FIG. 3 is a schematic diagram of a machine learning method using pooling on channel attention according to another embodiment of the present invention.

FIG. 4 is a schematic diagram of a machine learning method using pooling on channel attention according to another embodiment of the present invention.

FIG. 5 is a schematic diagram of a machine learning method using pooling on channel attention according to another embodiment of the present invention.

### DETAILED DESCRIPTION

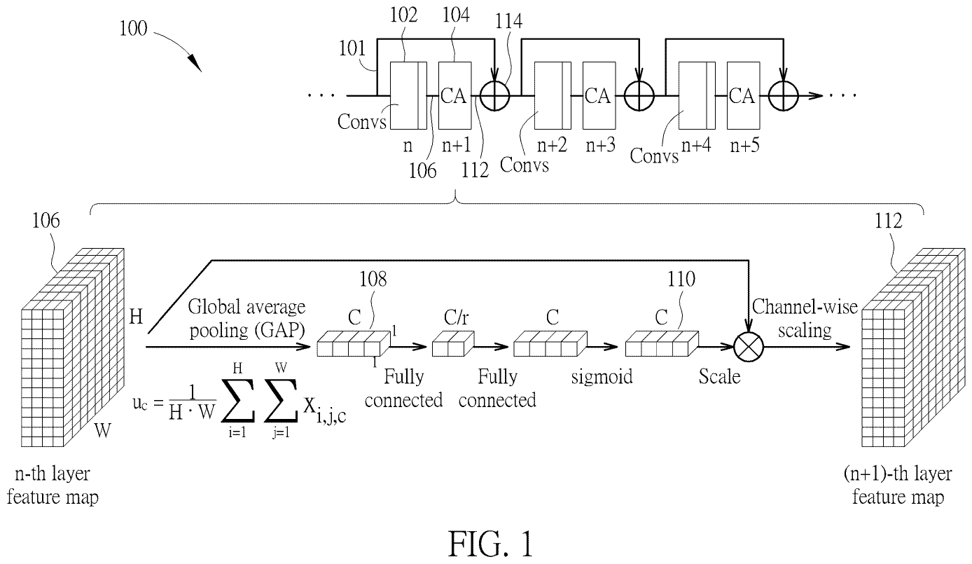

FIG. 1 is a schematic diagram of a channel attention method 100. In a CNN model, a convolutional layer 102 is added in front of a channel attention layer 104. The input data 101 (such as an image) is inputted into the convolutional layer 102. The convolutional layer 102 performs convolution on the input data 101 and output an n-th layer feature map 106. The n-th layer feature map 106 is a tensor with C×H×W dimensions. C is the dimension of channels, which is determined by the convolutional layer 102, H is the dimension of height, and W is the dimension of width. The C channels contains features of the input data 101. The channel attention layer 104 contains a transformation process from the n-th layer feature map 106 to an (n+1)-th layer feature map 112. The transformation process includes performing global average pooling (GAP) on the n-th layer feature map 106 to generate a pooling vector 108. GAP is a process to extract the features of the n-th layer feature map 106. The GAP process can be calculated as follows:

$${u}_{c} = \frac{1}{H W} {\sum }_{i = 1}^{H} {\sum }_{j = 1}^{W} {X}_{i , j , c}$$

Where u_{c} is an element of the pooling vector 108, and the X_{i,j,c} is an element of the n-th layer feature map 106, i and j are indices. Each channel of the pooling vector 108 contains a u_{c}.

The pooling vector 108 is inputted to fully connected layers and outputs a scaling vector 110. In an embodiment, the number of the fully connected layers may be, but is not limited to, 2. The last layer of the fully connected layers may be, but not limited to, sigmoid, ReLU or softmax. The scaling vector 110 is utilized to provide channel-wise scaling on the n-th layer feature map 106 to generate an (n+1)-th layer feature map 112. The n-th layer feature map 106 is stored in a dynamic random access memory (DRAM) for use in the channel-wise scaling process. The add layer 114 adds the input data 101 and the (n+1)-th layer feature map 112 together to generate a result. The input data 101 is stored in the DRAM for use in the add layer 114. However, loading the n-th layer feature map 106 and input data 101, which are of large sizes, is quite time-intensive and consumes a significant amount of memory space.

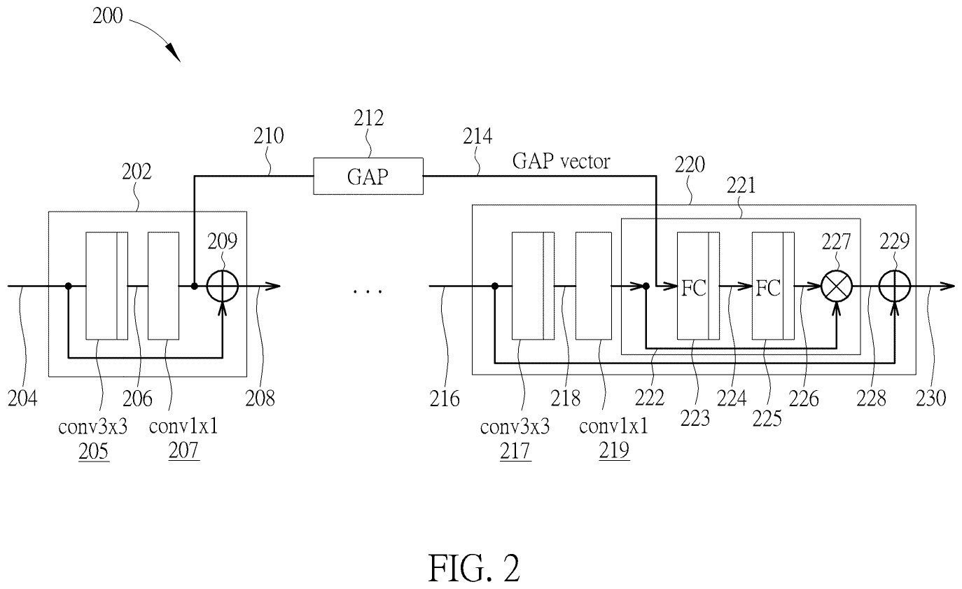

FIG. 2 is a schematic diagram of a machine learning method 200 using pooling on channel attention according to an embodiment of the present invention. A first residual input 204 is inputted into a first residual network 202 to generate a residual output 208. The first residual input 204 is input data (such as a feature map) with dimension C×H×W. The feature map may include features of any suitable image or imaging data.

The first residual network 202 includes an M×M convolution layer 205, an N×N convolution layer 207, and an add layer 209. M and N are positive integers. In an embodiment, M is 3 and N is 1. In an embodiment, the M×M convolution layer 205 and the N×N convolution layer 207 are used to extract the features of the input data. The first residual network 202 may contain but is not limited to 2 convolution layers. The first residual input 204 is inputted into the M×M convolution layer 205 to generate a temporarily convolved output 206, and the temporarily convolved output 206 is inputted to the N×N convolution layer 207 to generate a first convolved output 210. The residual output 208 is generated according to the first convolved output 210 and the first residual input 204. In an embodiment, the residual output 208 is generated by adding the first convolved output 210 and the first residual input 204 using the add layer 209. The residual output 208 is a tensor with dimension C×H×W, which is the feature map 106 in FIG. 1. C is the dimension of channels, H is the dimension of height, and W is the dimension of width. In an embodiment, the residual output 208 is stored in a dynamic random access memory (DRAM).

The first convolved output 210 is inputted to a first pooling layer 212 to generate a first pooling vector 214. The data amount of the first pooling vector 214 is small, thus it can be stored in the processor instead of the DRAM. In an embodiment, the first pooling layer 212 can be a global average pooling (GAP) layer, a global max pooling layer, a global min pooling layer, an average pooling layer, a max pooling layer, or a min pooling layer. The first pooling vector 214 is a vector with dimension C, and C is the number of channels. A network input 216 is generated according to the residual output 208, and the network input 216 is inputted to an M×M convolution layer 217 of a first residual channel attention network 220 to generate a temporarily convolved output 218. The temporarily convolved output 218 is then inputted to an N×N convolution layer 219 to generate a first attention input 222. Like the M×M convolution layer 205 and the N×N convolution layer 207, in an embodiment, M is 3 and N is 1. The first attention input 222 and the first pooling vector 214 are inputted to a channel attention network 221 of the first residual channel attention network 220 to generate a first attention output 228. The channel attention network 221 contains a plurality of fully connected layers and a channel-wise multiply layer 227. In an embodiment, the number of fully connected layers may be, but is not limited to 2. The first pooling vector 214 is inputted to the first fully connected layer 223 to generate a temporarily fully connected output 224, and the temporarily fully connected output 224 is inputted to the second fully connected layer 225 to generate a fully connected output 226. The fully connected output 226 is then channel wise multiplied with the first attention input 222 using the channel-wise multiply layer 227 to implement attention mechanism and generate the first attention output 228. The fully connected output 226 is a vector with dimension C for the scaling of each channel.

The first residual channel attention output 230 is then generated according to the first attention output 228 and the network input 216. In an embodiment, the first residual channel attention output 230 is generated by adding the first attention output 228 and the network input 216 using an add layer 229. The first residual channel attention output 230 may be an output image (such as a deblurred image, a denoise image, and a style transferred image). In an embodiment, the residual output 208 is stored in a dynamic random access memory (DRAM), and the network input 216 is generated by accessing the DRAM. By using the schematic diagram in FIG. 2, the number of accessing paths to the DRAM is limited to just one. This approach is not only time-efficient but also conserves a substantial amount of memory space.

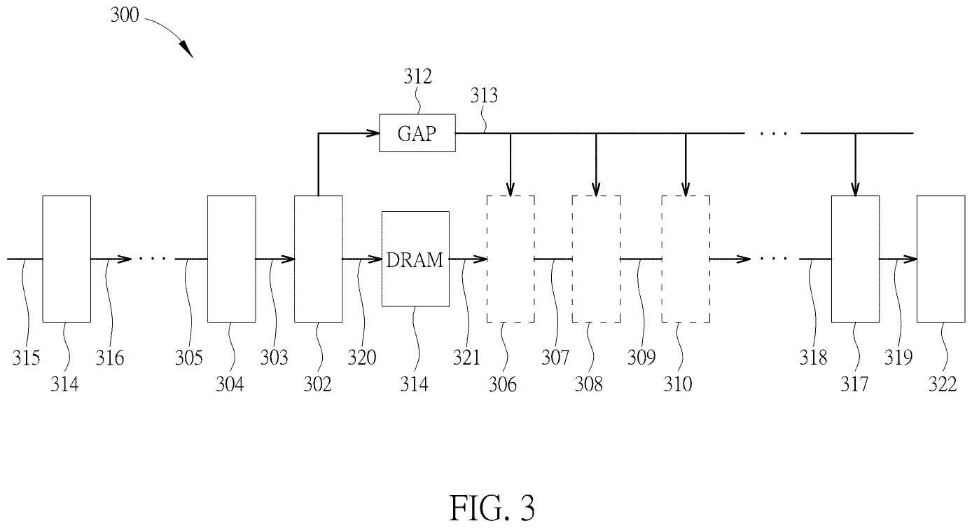

FIG. 3 is a schematic diagram of a machine learning method 300 using pooling on channel attention according to another embodiment of the present invention. An (n−1)th residual channel attention output 318 is inputted to convolution layers of an nth residual channel attention network 317 to generate an nth attention input. The first pooling vector 313 and the nth attention input are inputted to a channel attention network of the nth residual channel attention network 317 to generate an nth attention output. The first pooling vector 313 is a vector with dimension C, and C is the number of channels. An nth residual channel attention output 319 is generated according to the (n−1)th residual channel attention output 318 and the nth attention output. In an embodiment, the nth residual channel attention output 319 is generated by adding the (n−1)th residual channel attention output 318 and the nth attention output using an add layer of the nth residual channel attention network 317. An nth residual input 315 is inputted to convolution layers of an nth residual network 314 to generate an nth convolved output. An (n−1)th residual input 316 is generated according to the nth convolved output and the nth residual input 315. In an embodiment, the (n−1)th residual input 316 is generated by adding the nth convolved output and the nth residual input 315 using an add layer of the nth residual network 314. The nth residual input 315 is input data (such as input image data) with dimension C×H×W. n is an integer greater than 1.

In FIG. 3, the first residual channel attention output 307 is inputted to the second residual channel attention network 308 to generate a second attention input. The first pooling vector 313 and the second attention input are inputted to a channel attention network of the second residual channel attention network 308 to generate a second attention output. A second residual channel attention output 309 is generated according to the first residual channel attention output 307 and the second attention output. In an embodiment, the second residual channel attention output 309 is generated by adding the first residual channel attention output and the second attention output using an add layer of the second residual channel attention network 308. A second residual input 305 is inputted to convolution layers of a second residual network 304 to generate a second convolved output. A first residual input 303 is generated according to the second convolved output and the second residual input 305. In an embodiment, the first residual input 303 is generated by adding the second convolved output and the second residual input 305 using an add layer of the second residual network 304.

The second residual network 304 outputs the first residual input 303 to the first residual network 302. The first residual network 302 outputs the first convolved output to the first pooling layer 312 to generate the first pooling vector 313. The data amount of the first pooling vector 313 is small, thus it can be stored in the processor instead of DRAM. This first pooling vector 313 is reused for the first residual channel attention network 306, the second residual channel attention network 308, the third residual channel attention network 310, and the nth residual channel attention network 317. The first residual network 302 stores residual output 320 in a DRAM 314, and the network input 321 is loaded from the DRAM 314 to the first residual channel attention network 306. The residual output 320 is a tensor with dimension C×H×W, which is the feature map 106 in FIG. 1. C is the dimension of channels, H is the dimension of height, and W is the dimension of width. This is the only path to access the DRAM 314 in FIG. 3. Therefore, the embodiment reduces computing time and saves memory by reducing the access times to the DRAM 314. The first residual channel attention network 306 outputs the first residual channel attention output 307 to the second residual channel attention network 308. The second residual channel attention network 308 outputs the second residual channel attention output 309 to the third residual channel attention network 310. In an embodiment, the nth residual channel attention network 317 outputs the nth residual channel attention output 319 to an (n+1) residual channel attention network 322.

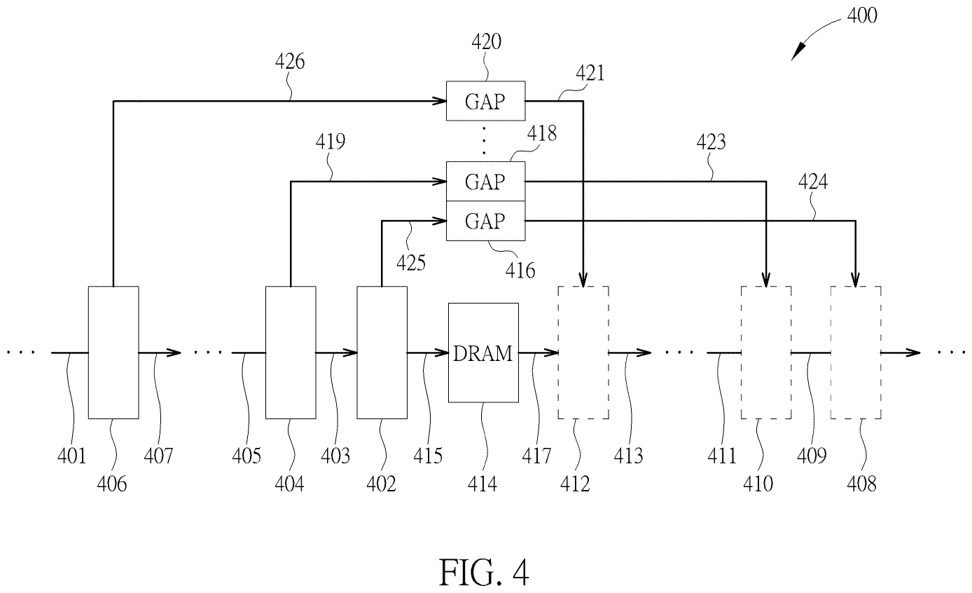

FIG. 4 is a schematic diagram of a machine learning method 400 using pooling on channel attention according to another embodiment of the present invention. An nth residual input 401 is inputted to convolution layers of an nth residual network 406 to generate an nth convolved output 426. The nth convolved output 426 is inputted to an nth pooling layer 420 to generate an nth pooling vector 421. The nth pooling vector 421 is a vector with dimension C, and C is the number of channels. In an embodiment, the nth pooling layer 420 can be a global average pooling (GAP) layer, a global max pooling layer, a global min pooling layer, an average pooling layer, a max pooling layer, or a min pooling layer. An (n−1)th residual input 407 is generated according to the nth convolved output 426 and the nth residual input 401. The nth residual input 401 is input data (such as input image data) with dimension C×H×W. In an embodiment, the (n−1)th residual input 407 is generated by adding the nth convolved output 426 and the nth residual input 401 using an add layer of the nth residual network 406. An (n+1)th residual channel attention output 417 is inputted to convolution layers of an nth residual channel attention network 412 to generate an nth attention input. The nth pooling vector 421 and the nth attention input are inputted to a channel attention network of the nth residual channel attention network 412 to generate an nth attention output. An nth residual channel attention output 413 is generated according to the (n+1)th residual channel attention output 417 and the nth attention output.

In an embodiment, the nth residual channel attention output 413 is generated by adding the (n+1)th residual channel attention output 417 and the nth attention output using an add layer of the nth residual channel attention network 412. In an embodiment, the (n+1)th residual channel attention output 417 is the network input 417.

In FIG. 4, the second residual input 405 is inputted to convolution layers of the second residual network 404 to generate a second convolved output 419. The second convolved output 419 is inputted to the second pooling layer 418 to generate a second pooling vector 423. In an embodiment, the second pooling layer 418 can be a global average pooling (GAP) layer, a global max pooling layer, a global min pooling layer, an average pooling layer, a max pooling layer, or a min pooling layer. The first residual input 403 is generated according to the second convolved output 419 and the second residual input 405. In an embodiment, the first residual input 403 is generated by adding the second convolved output 419 and the second residual input 405 using an add layer of the second residual network 404. The third residual channel attention output 411 is inputted to convolution layers of the second residual channel attention network 410 to generate the second attention input. The second pooling vector 423 and the second attention input are inputted to a channel attention network of the second residual channel attention network 410 to generate the second attention output. The second residual channel attention output 409 is generated according to the third residual channel attention output 411 and the second attention output. In an embodiment, the second residual channel attention output 409 is generated by adding the third residual channel attention output 411 and the second attention output using an add layer of the second residual channel attention network 410.

The first residual input 403 is inputted to the first residual network 402 to generate the first convolved output 425 and the residual output 415 to be stored in a DRAM 414. The network input 417 is loaded from the DRAM 414 to the nth residual channel attention network 412. The residual output 415 is a tensor with dimension C×H×W, which is the feature map 106 in FIG. 1. C is the dimension of channels, H is the dimension of height, and W is the dimension of width. The first convolved output 425 is inputted to the first pooling layer 416 to generate a first pooling vector 424. The first pooling vector 424 is then inputted to the first residual channel attention network 408. The second residual input 405 is inputted to the second residual network 404 to generate the second convolved output 419 and the first residual input 403. The second convolved output is inputted to the second pooling layer 418 to generate a second pooling vector 423. The second pooling vector 423 is then inputted to the second residual channel attention network 410. By doing so, the nth pooling vector 421 is inputted to the nth residual channel attention network 412.

The pooling vectors 421, 423, 424 are arranged in a first-in, first-out sequence. This allows for the DRAM 414 to be written and read just once, thereby reducing both computational time and memory space.

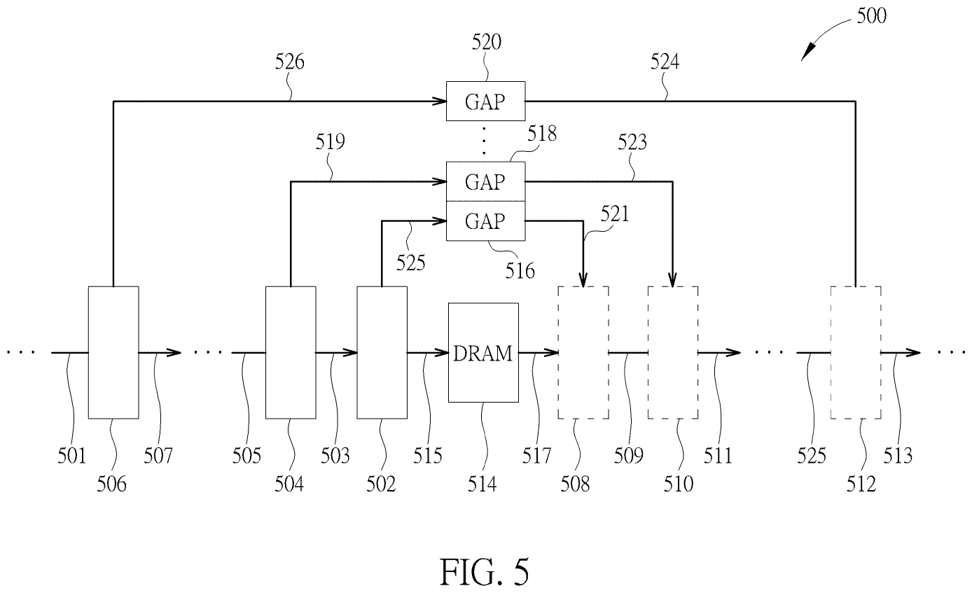

FIG. 5 is a schematic diagram of a machine learning method 500 using pooling on channel attention according to another embodiment of the present invention. An nth residual input 501 is inputted to convolution layers of an nth residual network 506 to generate an nth convolved output 526. The nth residual input 501 is input data (such as input image data) with dimension C×H×W. The nth convolved output 526 is inputted to an nth pooling layer 520 to generate an nth pooling vector 524. The nth pooling vector 524 is a vector with dimension C, and C is the number of channels. In an embodiment, the nth pooling layer 520 can be a global average pooling (GAP) layer, a global max pooling layer, a global min pooling layer, an average pooling layer, a max pooling layer, or a min pooling layer. An (n−1)th residual input 507 is generated according to the nth convolved output 526 and the nth residual input 501. In an embodiment, the (n−1)th residual input 507 is generated by adding the nth convolved output 526 and the nth residual input 501 using an add layer of the nth residual network 506. The (n−1)th residual channel attention output 525 is inputted to convolution layers of the nth residual channel attention network 512 to generate an nth attention input. The nth pooling vector 524 and the nth attention input are inputted to a channel attention network of the nth residual channel attention network 512 to generate an nth attention output. An nth residual channel attention output 513 is generated according to the (n−1)th residual channel attention output 525 and the nth attention output. In an embodiment, the nth residual channel attention output 513 is generated by adding the (n−1)th residual channel attention output 525 and the nth attention output using an add layer of the nth residual channel attention network 512.

In FIG. 5, the second residual input 505 is inputted to convolution layers of the second residual network 504 to generate an nth convolved output 519. The second convolved output 519 is inputted to an nth pooling layer 518 to generate a second pooling vector 523. In an embodiment, the second pooling layer 518 can be a global average pooling (GAP) layer, a global max pooling layer, a global min pooling layer, an average pooling layer, a max pooling layer, or a min pooling layer. The first residual input 503 is generated according to the second convolved output 519 and the second residual input 505. In an embodiment, the first residual input 503 is generated by adding the second convolved output 519 and the second residual input 505 using an add layer of the second residual network 504. The first residual channel attention output 509 is inputted to convolution layers of the second residual channel attention network 510 to generate a second attention input. The second pooling vector 523 and the second attention input are inputted to the channel attention network of the second residual channel attention network 510 to generate a second attention output. A second residual channel attention output 511 is generated according to the first residual channel attention output 509 and the second attention output. In an embodiment, the second residual channel attention output 511 is generated by adding the first residual channel attention output 509 and the second attention output using an add layer of the second residual channel attention network 510.

The first residual input 503 is inputted to the first residual network 502 to generate the first convolved output 525 and the residual output 515 to be stored in a DRAM 514. The residual output 515 is a tensor with dimension C×H×W, which is the feature map 106 in FIG. 1. C is the dimension of channels, H is the dimension of height, and W is the dimension of width. The network input 517 is loaded from the DRAM 514 to the first residual channel attention network 508. The first convolved output 525 is inputted to the first pooling layer 516 to generate a first pooling vector 521. The first pooling vector 521 is then inputted to the first residual channel attention network 508. The second residual input 505 is inputted to the second residual network 504 to generate the second convolved output 519 and the first residual input 503. The second convolved output 519 is inputted to the second pooling layer 518 to generate a second pooling vector 523. The second pooling vector 523 is then inputted to the second residual channel attention network 510. By doing so, the nth pooling vector 524 is inputted to the nth residual channel attention network 512. The pooling vectors 521, 523, 524 are arranged in a first-in, last-out sequence. This allows for the DRAM 514 to be written and read just once, thereby reducing both computational time and memory space.

In conclusion, the embodiments modify the architecture of the machine learning method that employs pooling on channel attention. This results in the number of write and read operations to the DRAM being limited to just one. Consequently, this leads to a reduction in computational time and memory space, thereby enhancing the efficiency and performance of the machine learning model.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A machine learning method using pooling on channel attention, comprising:
inputting a first residual input to convolution layers of a first residual network to generate a first convolved output; and
inputting the first convolved output to a first pooling layer to generate a first pooling vector.

2. The method of claim 1, wherein inputting the first residual input to the convolution layers of the first residual network to generate the first convolved output comprises:
inputting the first residual input to an M×M convolution layer to generate a temporarily convolved output; and
inputting the temporarily convolved output to an N×N convolution layer to generate the first convolved output;
wherein M, N are positive integers.

3. The method of claim 1, wherein inputting the first convolved output to the first pooling layer to generate the first pooling vector is inputting the first convolved output to a global average pooling layer, a global max pooling layer, a global min pooling layer, an average pooling layer, a max pooling layer, or a min pooling layer to generate the first pooling vector.

4. The method of claim 1, further comprising:
generating a residual output according to the first convolved output and the first residual input;
inputting a network input to convolution layers of a first residual channel attention network to generate a first attention input, the network input being generated according to the residual output;
inputting the first pooling vector and the first attention input to a channel attention network of the first residual channel attention network to generate a first attention output; and
generating a first residual channel attention output according to the network input and the first attention output.

5. The method of claim 4, wherein inputting the network input to the convolution layers of the first residual channel attention network to generate the first attention input comprises:
inputting the network input to an M×M convolution layer to generate a temporarily convolved output; and
inputting the temporarily convolved output to an N×N convolution layer to generate the first attention input;
wherein M, N are positive integers.

6. The method of claim 4, wherein inputting the first pooling vector and the first attention input to the channel attention network to generate the first attention output comprises:
inputting the first pooling vector to a first fully connected layer to generate a temporarily fully connected output;
inputting the temporarily fully connected output to a second fully connected layer to generate a fully connected output; and
inputting the first attention input and the fully connected output to a channel-wise scaling layer to generate the first attention output.

7. The method of claim 4, wherein generating the residual output according to the first convolved output and the first residual input is adding the first convolved output and the first residual input to generate the residual output.

8. The method of claim 4, wherein generating the first residual channel attention output according to the network input and the first attention output is adding the network input and the first attention output to generate the first residual channel attention output.

9. The method of claim 4, further comprising:
inputting the residual output to a dynamic random access memory; and
outputting the network input from the dynamic random access memory.

10. The method of claim 1, further comprising:
inputting an (n−1)th residual channel attention output to convolution layers of an nth residual channel attention network to generate an nth attention input;
inputting the first pooling vector and the nth attention input to a channel attention network of the nth residual channel attention network to generate an nth attention output; and
generating an nth residual channel attention output according to the (n−1)th residual channel attention output and the nth attention output;
wherein n is an integer greater than 1.

11. The method of claim 10, wherein generating the nth residual channel attention output according to the (n−1)th residual channel attention output and the nth attention output is adding the (n−1)th residual channel attention output and the nth attention output to generate the nth residual channel attention output.

12. The method of claim 10, further comprising:
inputting an nth residual input to convolution layers of an nth residual network to generate an nth convolved output; and
generating an (n−1)th residual input according to the nth convolved output and the nth residual input.

13. The method of claim 12, wherein generating the (n−1)th residual input according to the nth convolved output and the nth residual input is adding the nth convolved output and the nth residual input to generate the (n−1)th residual input.

14. The method of claim 1, further comprising:
inputting an nth residual input to convolution layers of an nth residual network to generate an nth convolved output;
inputting the nth convolved output to an nth pooling layer to generate an nth pooling vector; and
generating an (n−1)th residual input according to the nth convolved output and the nth residual input;
wherein n is an integer greater than 1.

15. The method of claim 14, wherein generating the (n−1)th residual input according to the nth convolved output and the nth residual input is adding the nth convolved output and the nth residual input to generate the (n−1)th residual input.

16. The method of claim 14, further comprising:
inputting an (n+1)th residual channel attention output to convolution layers of an nth residual channel attention network to generate an nth attention input;
inputting the nth pooling vector and the nth attention input to a channel attention network of the nth residual channel attention network to generate an nth attention output; and
generating an nth residual channel attention output according to the (n+1)th residual channel attention output and the nth attention output;
wherein the network input is a (n+1)th residual channel attention output.

17. The method of claim 16, wherein generating the nth residual channel attention output according to the (n+1)th residual channel attention output and the nth attention output is adding the (n+1)th residual channel attention output and the nth attention output to generate the nth residual channel attention output.

18. The method of claim 16, further comprising:
inputting the residual output to a dynamic random access memory; and
outputting an (N+1)th residual channel attention output from the dynamic random access memory to convolution layers of an Nth residual network;
wherein N is a total number of pooling layers.

19. The method of claim 14, further comprising:
inputting an (n−1)th residual channel attention output to convolution layers of an nth residual channel attention network to generate an nth attention input;
inputting the nth pooling vector and the nth attention input to a channel attention network of the nth residual channel attention network to generate an nth attention output; and
generating an nth residual channel attention output according to the (n−1)th residual channel attention output and the nth attention output.

20. The method of claim 19, wherein generating the nth residual channel attention output according to the (n−1)th residual channel attention output and the nth attention output is adding the (n−1)th residual channel attention output and the nth attention output to generate the nth residual channel attention output.
